(19) United States
(12) Patent Application Publication
(10) Pub. No.: US 2022/0248616 A1
(43) Pub. Date: Aug. 11, 2022

(54) IRRIGATION CONTROL WITH DEEP REINFORCEMENT LEARNING AND SMART SCHEDULING

(71) Applicant: THE TEXAS A&M UNIVERSITY SYSTEM, College Station, TX (US)

(72) Inventors: Yanxiang YANG, College Station, TX (US); Hongxin KONG, College Station, TX (US); Jiang HU, College Station, TX (US); Dana O. PORTER, Wolfforth, TX (US); Thomas H. MAREK, Amarillo, TX (US); Kevin R. HEFLIN, Amarillo, TX (US)

(73) Assignee: The Texas A&M University System, College Station, TX (US)

(21) Appl. No.: 17/624,594

(22) PCT Filed: Jul. 8, 2020
(86) PCT No.: PCT/US20/41270

§ 371 Date: Jan. 4, 2022

Related U.S. Application Data
(60) Provisional application No. 62/871,846, filed on Jul. 9, 2019.

(51) Int. Cl. A01G 25/16; G05B 13/02; B64C 39/02

(52) U.S. Cl. CPC A01G 25/167; A01G 25/165; B64C 2201/123; B64C 39/024; G05B 13/027

(57) ABSTRACT

Disclosed are various embodiments for deep reinforcement learning-based irrigation control to maintain or increase crop yield and/or other desired crop status, and/or reduce water use. One or more computing devices can be configured to determine an amount of water to be applied to at least one crop in at least one of a plurality of irrigation management zones through execution of a deep reinforcement learning routine. Further, the computing devices can determine a start time and an end time to be applied to the at least one of the plurality of irrigation management zones based at least in part on the amount of water determined by the deep reinforcement learning module. Finally, the computing devices can instruct an irrigation system to apply irrigation to the at least one of the plurality of irrigation management zones in accordance with the start time and the end time.

### CROSS-REFERENCE TO RELATED APPLICATION

This application claims the benefit of and priority to U.S. Provisional Patent Application No. 62/871,846 entitled “IRRIGATION CONTROL WITH DEEP REINFORCEMENT LEARNING AND SMART SCHEDULING,” filed Jul. 9, 2019, the contents of which being incorporated by reference in their entirety herein.

### BACKGROUND

Irrigation management plays a critical role in determining crop yield. Crop yield largely depends on a sufficient water availability to prevent excessive drought stress. In areas with insufficient in-season rainfall, this means crop yields are dependent upon irrigation. Yet, freshwater resources are increasingly limited. Ideally, farmers should irrigate an exact amount of water that is needed by crop, no more and no less. Historically, such precise irrigation control is complex and difficult, if not impossible. However, wireless sensors, computer networking, and advanced irrigation machines currently enable site-specific variable rate irrigation (SSVRI), make precise irrigation control feasible.

In artificial intelligence and machine learning applications, reinforcement learning (RL) relates to an area of computer engineering and science concerned with how artificial intelligence applications determine actions to take in an environment so as to maximize a reward. Like a human, artificial intelligence applications applying reinforcement learning can autonomously learn to achieve successful strategies that lead to long-term rewards based on trial-and-error. For instance, a decision made by the artificial intelligence application may cause the application to receive either a reward or a penalty. Deep reinforcement learning is a subset of machine learning that trains a computer system to iteratively perform calculations so that a computing device can autonomously determine patterns of optimal decisions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing illustrating a traditional closed-loop irrigation system.

FIG. 2 is a drawing illustrating a machine learning-based irrigation advisor system.

FIG. 3 is a drawing illustrating an example of a reinforcement learning irrigation system according to various embodiments of the present disclosure.

FIG. 4A is a schematic diagram illustrating an example of an interaction between an agent and an environment in a reinforcement learning module according to various embodiments of the present disclosure.

FIG. 4B is a schematic diagram illustrating an example of an interaction between a controller and an environment in a reinforcement learning module according to various embodiments of the present disclosure.

FIG. 5 is a schematic diagram illustrating an example of a proposed deep reinforcement learning irrigation system structure according to various embodiments of the present disclosure.

FIG. 6 is pseudocode for a deep reinforcement learning irrigation routine according to various embodiments of the present disclosure.

FIG. 7 is an example of an irrigation zone scheduling solution given hydraulic constraints according to various embodiments of the present disclosure

FIG. 8 is pseudocode for a smart zone scheduling routine according to various embodiments of the present disclosure.

FIG. 9 is pseudocode for a validation routine (“VALIDATE”) according to various embodiments of the present disclosure.

FIGS. 10A-10C are graphs showing a comparison of different irrigation scheduling methods on varying weather conditions according to various embodiments of the present disclosure.

FIGS. 11A-11C are graphs showing learning curves for Q learning and Deep Q networks on different crops according to various embodiments of the present disclosure.

FIGS. 12A-12C are graphs showing a comparison of different irrigation scheduling methods on different crops according to various embodiments of the present disclosure.

FIGS. 13A and 13B are graphs showing soil water content level during an entire growing season using a smart schedule module according to various embodiments of the present disclosure shown relative to naive scheduling methods.

FIG. 14 is an example of a Q-Network according to various embodiments of the present disclosure shown relative to naive scheduling methods.

### DETAILED DESCRIPTION

The present disclosure relates to irrigation control with deep reinforcement learning and smart scheduling. According to various embodiments of the present disclosure, a system for deep reinforcement learning-based irrigation control is provided to maintain or increase a crop yield (or other desired crop status) or reduce water use. In various embodiments, the system includes (i) a deep reinforcement learning (RL) module configured to execute a deep reinforcement learning routine that determines an amount of water to be applied to at least one crop in at least one of a plurality of irrigation management zones, and (ii) an automated irrigation zone scheduling module configured to determine a start time and an end time to be applied to at least one of the irrigation management zones based at least in part on the amount of water determined by the deep reinforcement learning module. Further, the system may include an irrigation system, or can instruct an external irrigation system to apply irrigation to at least one of the irrigation management zones in accordance with the start time and the end time. In some embodiments, the at least one computing device can be implemented in an irrigation controller or, for instance, in a computing device separate from and communicatively coupled to the irrigation controller. In some embodiments, the irrigation controller is a micro-irrigation controller or an irrigation controller for a similarly activated irrigation system (with fixed, multiple zones, for example).

While the embodiments described herein relate to irrigation controllers and the application or use of water, the disclosure is not so limited. For instance, the operations of the irrigation controller can also include chemigation applications, which include fertigation or other chemigation applications through micro-irrigation systems. In some examples, in addition to or in place of determining an amount of water to be applied and a schedule for the water, the embodiments described herein can be used to determine an amount of an additive or other chemical, such as nitrogen and/or other fertilizers, pesticides, irrigation system disinfection and maintenance chemicals, etc., and a schedule associated therewith to applied to a crop or landscape using an irrigation system.

Water covers most of the planet, but fresh water is relatively limited. Only 3% of the planet's water constitutes fresh water, which is in increasing demand due to human population growth and climate fluctuations. Agricultural irrigation is the major consumer of freshwater resources and, therefore, plays a critical role in potential water savings and conservation efforts. As such, improving water use efficiency (WUE) is an important goal in agriculture. The same goal is also important and applicable for systems with urban based landscapes, including for example golf courses.

Traditionally, fixed or manual irrigation scheduling is widely used by farmers. This strategy includes a farmer or other individual irrigating a fixed amount of water per a given time interval. This simplified irrigation strategy often results in water loss and a reduction in crop productivity. In recent years, more precise irrigation strategies based on sensor data have been studied. However, most of these strategies apply thresholds or simplistic models for decision making, thus, these strategies involve inaccurate or non-optimal irrigation events. Irrigation events include the application of water to a crop or landscape, as can be appreciated.

Typically, for sensor-based irrigation scheduling, an expert is needed to interpret sensor data and convert the data to appropriate threshold values for use with a scheduling model. The process can be complicated in cases of a relatively large number of irrigation zones, rapidly changing weather, soil variability, crop types, and the different water needs at various growth stages of one or more crops. In addition, the amount of sensor data makes scheduling in real-time even more challenging due to possibly contradictory data from different types of sensors and other data sources. Another drawback of manual computed thresholds or models is the time-consuming aspect and lack of scalability. To overcome the issues of existing systems, various embodiments described herein relate to machine learning (ML) techniques to automate the process of determining an amount of water or other additive to apply to a crop at a particular period of time.

Linear regression and neural networks are used to extract useful information from sensor data, such as calculating a scheduling model. However, such linear regression and neural network-based approaches require manual oversight to analyze and manually control irrigation events. According to various embodiments, a reinforcement learning-based irrigation controller is described that can achieve fully automatic and optimal (or near-optimal) control. However, traditional reinforcement learning can only cover limited state space and, therefore, is difficult to accurately capture the entire, realistic irrigation environment.

There is no deep reinforcement learning-based irrigation system in existing technologies. Also, current commercially available micro-irrigation systems typically rely heavily on users to calculate the schedule to ensure compliance of hydraulic constraints and avoidance of water hammer, for instance. However, the embodiments described herein can automate this procedure. Further, the embodiments described herein provide a way to control irrigation of a large number of zones.

According to various embodiments described herein, a smart irrigation controller is provided that can be described, for convenience purposes, as having two components: (i) a deep reinforcement learning-based module that executes a deep reinforcement learning routine to determine precise irrigation water application of an individual zone and (ii) an automated irrigation zone scheduling module that determines start and stop times of multi-zonal micro-irrigation or other fixed-zone irrigation systems. By using this approach, fully automated control and high water use efficiency can be achieved. Moreover, the embodiments described herein are readily scalable and can handle high-dimensional sensory inputs. For instance, in some embodiments, an additional input of imagery data (e.g., derived or collected using one or more unmanned aerial vehicles) can be used to determine several production parameters using machine learning optimization assessments.

More specifically, in various embodiments, a system, a method, and a non-transitory computer-readable medium for deep reinforcement learning-based irrigation control are provided to maintain or increase a crop yield or reduce water use. For example, a system can include at least one computing device and program instructions stored in memory and executable by the at least one computing device that, when executed, direct the at least one computing device to (i) determine, by a deep reinforcement learning (RL) module, an amount of water to be applied to at least one crop in at least one of a plurality of irrigation management zones; (ii) determine, by an automated irrigation zone scheduling module, a start time and an end time to be applied to the at least one of the plurality of irrigation management zones based at least in part on the amount of water determined by the deep reinforcement learning module; and (iii) instruct an irrigation system to apply irrigation to the at least one of the plurality of irrigation management zones in accordance with the start time and the end time.

In additional embodiments, a control system can allow users to apply at least three different levels of control, such as manual, hybrid, automatic, etc. For instance, an automatic level of control may let the controller described herein perform irrigations or other decisions autonomously, whereas the manual control may require approval from an operator before irrigation or other events occur. Hybrid may include a combination of automatic and manual, as may be appreciated, where some events are performed autonomously and others manually or upon confirmation by the operator. In some embodiments, the control system includes a web-based control system that can be accessed from a client device over a network, such as the Internet. In other embodiments, the control system includes a standalone that can be accessed on a client device with or without use of a network (e.g., a client application). The control system can further be utilized to oversee simulation and training of the deep reinforcement learning model in various embodiments. The proposed control system can include a user-friendly interface such that the irrigation can be controlled, important statuses (e.g., water flow, water pressure, weather status, irrigation status, and soil moisture) can be observed, etc.

In some embodiments, the at least one computing device is implemented in an irrigation controller (e.g., an irrigation controller such as a micro-irrigation irrigation system controller) or a computing device communicatively coupled to the irrigation controller. The deep reinforcement learning module can determine the amount of water to be applied to at least one crop in at least one of a plurality of irrigation management zones based on at least one of: a hydraulic constraint (e.g., water flow and water pressure); a soil moisture measurement; a soil characteristic; current irrigation status; a crop status; imagery data; weather data, and other useful characteristics, as may be appreciated. The current irrigation status can include whether a crop is currently being irrigated, how long the crop has been irrigated, which zones have been irrigated, which zones are currently being irrigated, which zones are pending irrigation, etc.

In some embodiments, the imagery data include aerial imagery data obtained by an unmanned aerial vehicle (UAV). It is understood that various characteristics of a crop status can be derived from the UAV data, such as plant height, plant population, canopy cover, plant color, plant vigor, plant temperature, nutrient status, etc., which can be used by the deep reinforcement learning module in determining an amount of water (and constituent) to be applied to an irrigation zone having a crop planted therein.

The system can further include a plurality of soil sensors placed in individual ones of the plurality of irrigation management zones, the soil sensors being configured to generate at least one of: the soil moisture (soil water) measurement; the soil characteristics; and the crop water, and/or nutrient status. Additionally, the deep reinforcement learning module can further determine an amount of an additive or chemical (e.g., nitrogen and/or other fertilizers, pesticides, herbicides, soil or water conditioners, chlorine, acids, etc.) to be introduced in place of or with the water to be applied to a crop in at least one of the irrigation management zones.

In accordance with the embodiments described herein, a series of simulations and experiments were conducted to assess the improvements over existing systems. Notably, performance of the deep reinforcement learning (DRL) module described herein was compared with traditional reinforcement learning (RL), threshold-based irrigation, and fixed interval irrigation scheduling. The deep reinforcement learning-based module described herein can determine optimal or near-optimal water application for specified irrigation management zones.

However, the scheduling of fixed-zone irrigation systems, such as with a subsurface drip irrigation (SDI), landscape irrigation, or greenhouse/nursery systems, can be challenging, for instance, considering hydraulic constraints (e.g., water flow, pressure, system capacity, etc.). For example, an abrupt change in flow (and subsequent water hammer) may cause damage to the irrigation system. To protect the irrigation system from large fluctuations in flow and pressure, an automated irrigation zone scheduling module for system based multi-zonal micro-irrigation is further described herein, which replaces manual control computations generally required to determine start and stop times, and make the overall scheduling process more applicable and efficient than in a manual mode of operation. The automated irrigation zone scheduling module determines start and stop times based at least in part on the system hydraulic constraints, such as water flow, pressure, system capacity, etc. In various embodiments, the system described herein may include one or more sensors, such as wireless soil characteristic sensors. By using wireless sensor technology, the water use efficiency of agricultural irrigation can be appreciably improved.

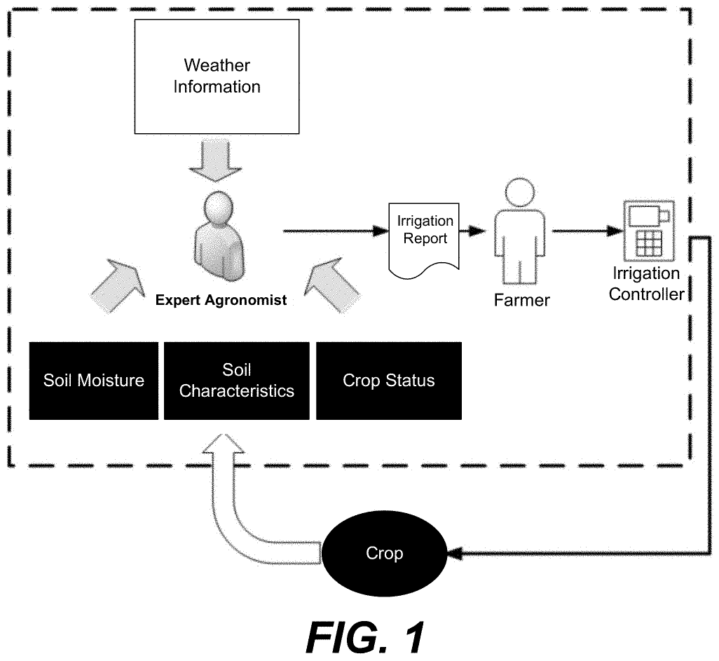

Prior systems exist that can make irrigation decisions based on near-term environment status and reduce unnecessary irrigation events. Usually, the prediction of irrigation water application amount is determined by an experienced farmer or an expert agricultural technician or operator in the case of urban based operations, as per the system diagram in FIG. 1. In this scenario, an expert agronomist, agricultural engineer, farmer, or operator is required to collect and analyze information from different sources, such as weather conditions, soil characteristics, nutrient reports, crop status, and soil water levels. The manual calculation and analysis can be very tedious and time consuming. Moreover, system management becomes unmanageable with an increasingly large number of sensory inputs and zones.

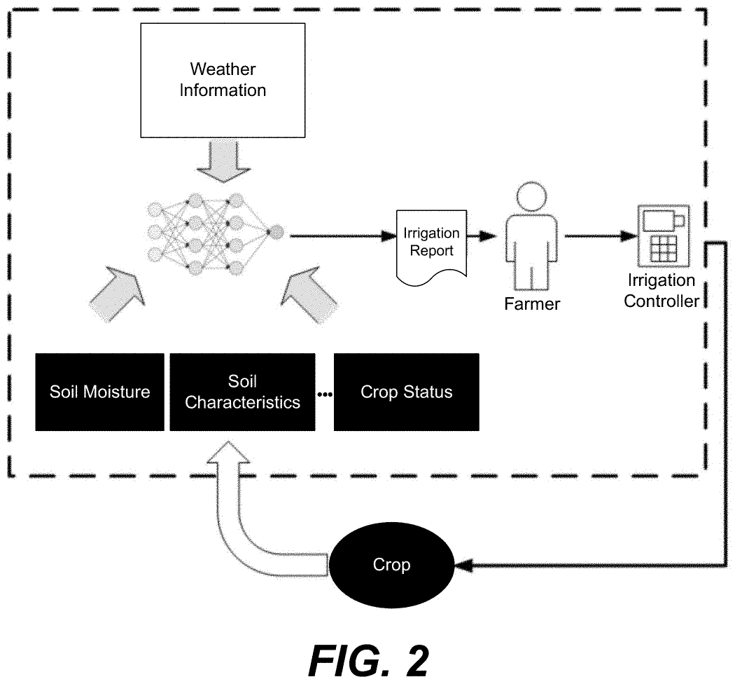

Some systems can employ a neural network-based irrigation approach. An example system is labeled as a smart-irrigation-decision-support-system (SIDSS), which is depicted in FIG. 2. In this system, a machine learning-based model is used to replace the manual calculation and analysis. All of the information or sensor inputs are handled by the machine learning model. Then, a farmer, crop consultant, or operator can determine an irrigation event decision based on the irrigation report, which is the output of the machine learning model. However, the system shown in FIG. 2 relies heavily on historical data and further lacks the ability to “learn” from a changing environment. Moreover, it still requires human intervention to manually control an irrigation machine and event or to manually program the start/stop times of the irrigation zones.

Other systems may implement a model-based irrigation strategy. This strategy determines event decisions based on either short-term (e.g. achieving/maintaining a set of soil-water deficit values) or predicted end-of-season effects (e.g. maximizing final yield). This strategy can potentially achieve more precise irrigation than offline approaches using traditional optimization techniques. However, this strategy relies heavily on accurate mathematic models, and associated inputs and assumptions. Also, this strategy lacks the ability to further adapt the model to differing or multiple environments. Some other systems can employ a neuro-dynamic programming method, where a model-based reinforcement learning technique is applied to determine irrigation decisions. However, the oversimplified model results in substantial inaccuracies.

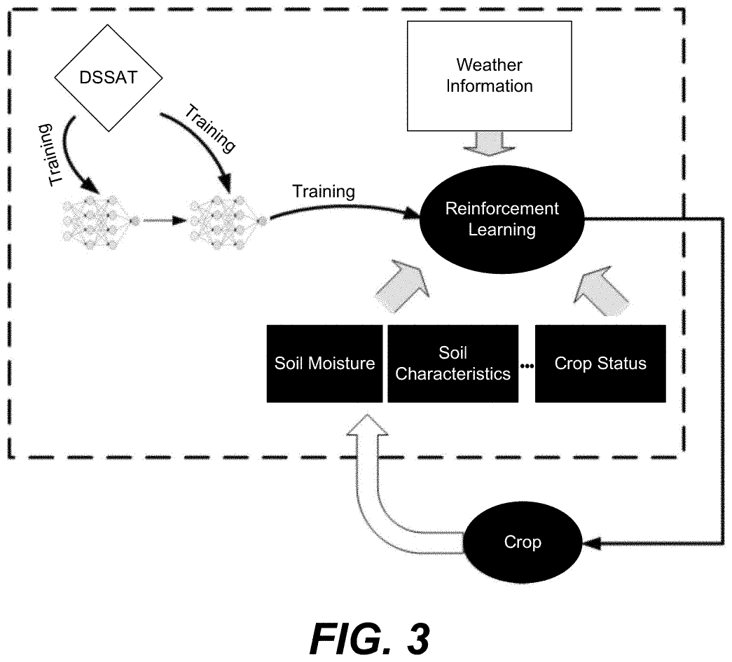

Some systems employ a reinforcement learning-based irrigation control system, as shown in FIG. 3. Specifically, these systems rely on a model-free reinforcement learning algorithm to determine both decision making and irrigation control. Two neural networks (NNs) are introduced to predict the Decision Support System for Agrotechnology Transfer (DSSAT) simulation results. Hoogenboom, G., C. H. Porter, V. Shelia, K. J. Boote, U. Singh, J. W. White, L. A. Hunt, R. Ogoshi, J. I. Lizaso, J. Koo, S. Asseng, A. Singels, L. P. Moreno, and J. W. Jones, “Decision Support System for Agrotechnology Transfer (DSSAT) Version 4.7.5,” https://DSSAT.net, DSSAT Foundation (2019) (last visited: Jul. 7, 2020). A first neural network inputs irrigation and weather information and predicts total soil water content, while a second neural network predicts crop yield given daily total soil water content of an entire crop season. Subsequently, prediction of the crop yield is used as the training data to train the reinforcement learning model. The basic structure is depicted in FIG. 3. This approach achieved relatively precise irrigation and provides full automation of the irrigation process. However, the state space is limited. Therefore, it is difficult to accurately represent actual irrigation context, leading to loss of important information that may affect the needed irrigation application amount.

According to various embodiments described herein, a system includes a deep reinforcement learning irrigation module and an automated zone scheduling module. The deep reinforcement learning irrigation module precisely determines a water application amount needed in terms of current environmental, soil and crop information. This achieves the greatest long-term net economic return, while the automated zone scheduling module is employed to “smartly” and automatically determine start and stop times for irrigating a large number of irrigation management zones.

The embodiments described herein provide significant improvements over the existing state of the art, namely, as the embodiments described herein accurately present complicated irrigation context and determine precise water application amounts; overcome insufficient data issues and enable the system to continuously learn during a production season; and replace manual computations that are required to determine start and stop times to provide the desired water application rate and timing for fixed-zone irrigation system. Additionally, the automated zone scheduling determined according to the embodiments described herein can be more than twenty-thousand times faster than manual computation while protecting the system from large fluctuations in flow and pressure and assures system operation within the given hydraulic constraints.

Deep reinforcement learning has attracted a lot of attention since a particular deep reinforcement learning algorithm, deep Q-networks (DQN), was introduced. DQN has been proved to surpass human experts in some computer-based video games. Researchers have yet to study or adapt DQN to agricultural irrigation control. In the present disclosure, a deep reinforcement learning-based irrigation routine is employed by one or more modules, which can overcome the drawbacks of traditional reinforcement learning and/or other machine learning-based irrigation control, as will become apparent to those skilled in the art.

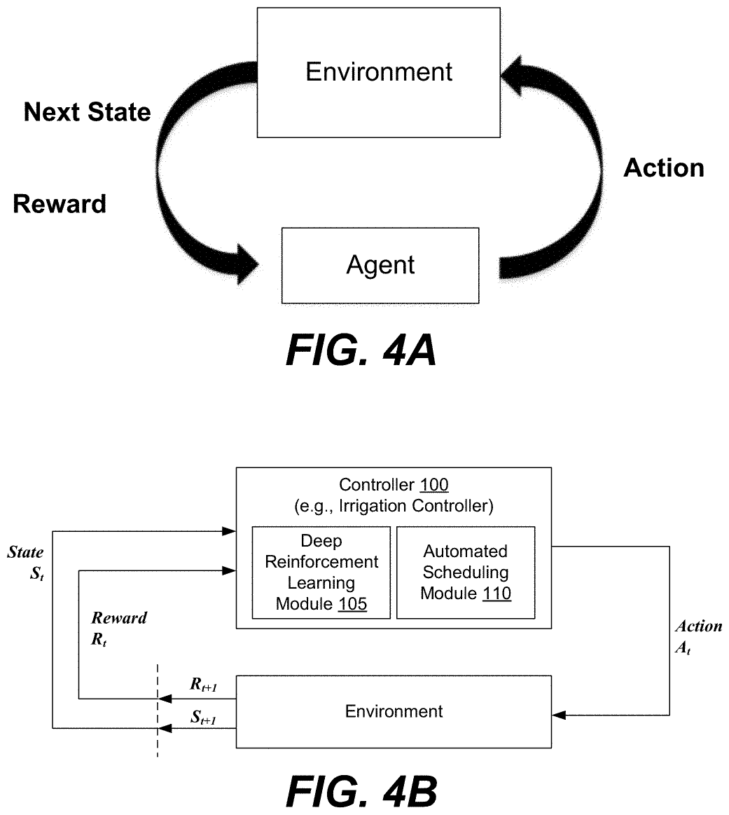

Problem Formulation. Reinforcement learning is typically used to deal with the problem of a goal-directed agent interacting with an uncertain environment, as shown in FIG. 4A. The agent may include a controller 100, for example, such as an irrigation controller. FIG. 4B includes a schematic diagram illustrating an example of an interaction between a controller 100 and an environment that includes a deep reinforcement learning module 105 and an automated scheduling module 110 according to various embodiments of the present disclosure. It is understood that the controller 100 includes at least one computing device, which may be implemented via a microcontroller, a personal computing device, one or more integrated circuits (IC), etc., as may be appreciated. It is further understood that the controller 100 may include an irrigation controller in some embodiments.

Referring collectively to FIGS. 4A and 4B, according to various embodiments, a set of states S={s1, s2, . . . } can be used to model a status of an environment. For agricultural irrigation, the states include real world observations, which can include environmental information collected by one or more sensors, such as soil water content, weather conditions, soil profile characteristics, crop growth status, nutrient status, etc. An entire irrigation system can be referred to as an agent. The different choices of water application amounts correspond to different actions A={a₀, a₁, a₂, . . . aₖ}.

Seasonal net return is the reward referred to as R. Agricultural irrigation scheduling requires a sequence of decisions of water application amounts and that is evaluated by the long-term net return results from the decisions. Thus, a deep reinforcement learning irrigation problem can be described as that of finding an optimal policy π: S→A so that if in each state s the agent takes action π(s), it will obtain maximum expected sum of rewards:

E_{π}[R₀+γR₁+γR₂+ . . . ] (eq. 1),

where γ is the discount factor that determines the importance of future rewards. Therefore, the expected sum of rewards can be maximized, and the decision variable is the policy π.

A predefined reward function can be used to indicate what states and actions are preferred. In some embodiments, the reward function can be defined as follows:

Reward=Yield*Price_{crop}−Irrigation*Price_{water} (eq. 2),

where Yield is crop yield with unit ton/ha, Irrigation is the total irrigation amount with unit ha−mm/ha, and Price_{crop} and Price_{water} represent the crop price and water price (costs associated with irrigation), respectively. Other suitable reward functions can be used, as can be appreciated.

At a certain state s, if the agent takes some action a, the quality of state-action pair can be indicated by action-value function Q(s, a). Q*(s, a) indicates the optimal action value given some policy π.

Q(s,a)=E[Rₜ|sₜ=s,aₜ=a] (eq. 3),

Q*(s,a)=max_{π}E[Rₜ|sₜ=s,aₜ=a,π] (eq. 4).

A well-known approach to calculate the optimal [symbol] is to iteratively update the equation (5), reproduced below. After certain number of iterations, the [symbol] values can converge to the optimal solution. After obtaining the optimal [symbol] for every state and action pair, the optimal policy can be derived, which “tells” the agent the best action to take at a given state.

$$Q ( {s}_{t} , {a}_{t} ) = Q ( {s}_{t} , {a}_{t} ) + a [ {r}_{t} + γ {max}_{{a}_{t + 1}} Q ( {s}_{t + 1} , {a}_{t + 1} ) - Q ( {s}_{t} , {a}_{t} ) ] . \qquad ( eq . 5 )$$

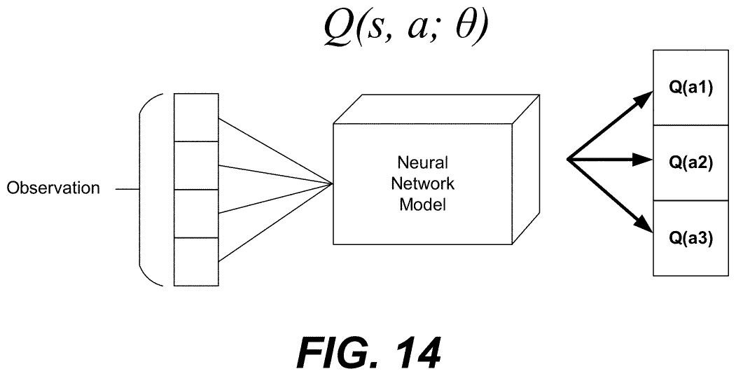

Deep Q-Networks Irrigation System. An example of a Q-network is shown in FIG. 14, where a single feed-forward pass is performed to compute Q-values for all actions from a current state. As shown in FIG. 14, the last layer (e.g., Q(a1) . . . Q(a3)) has a three unit output, assuming there are three actions to perform. Traditional reinforcement learning (Q learning) manually defines the states and stores a Q table while learning from data. On the other hand, deep reinforcement learning treats the multi-dimensional sensor inputs as the observation of the real world and uses artificial neural networks to approximate the Q function. Artificial neural networks can handle large quantities of sensor data and make the proposed irrigation approach scalable. Given an irrigation agent, at each time-step, the agent selects an action at from the set of legal actions, A={a₀, a₁, a₂, . . . , aₖ}, where each action corresponds to a specific water application amount. In some embodiments, the action can be passed to an environment emulator interfaced with a third-party service (e.g., the AquaCrop model, or other crop and/or weather model) to calculate the reward in terms of predicted yield and water consumption.

In DQN, the current observation of the environment (using multi-sensor inputs, for example) xₜ is used to indicate the current state sₜ. The goal of the irrigation agent is to interact with a real environment and/or a crop model, such as AquaCrop, by selecting actions in a manner that maximizes the long-term return. An important technique in DQN is experience replay. The experience at each time-step, eₜ=(sₜ, aₜ, rₜ, sₜ₊), can be stored into a replay memory, where the replay memory has a limited size in some embodiments where rₜ is the reward at time step t. Once a maximum size is reached, a newest experience can overwrite an oldest experience. The experience replay can apply mini-batch training for the artificial neural networks that are used to approximate the Q function using samples from replay memory.

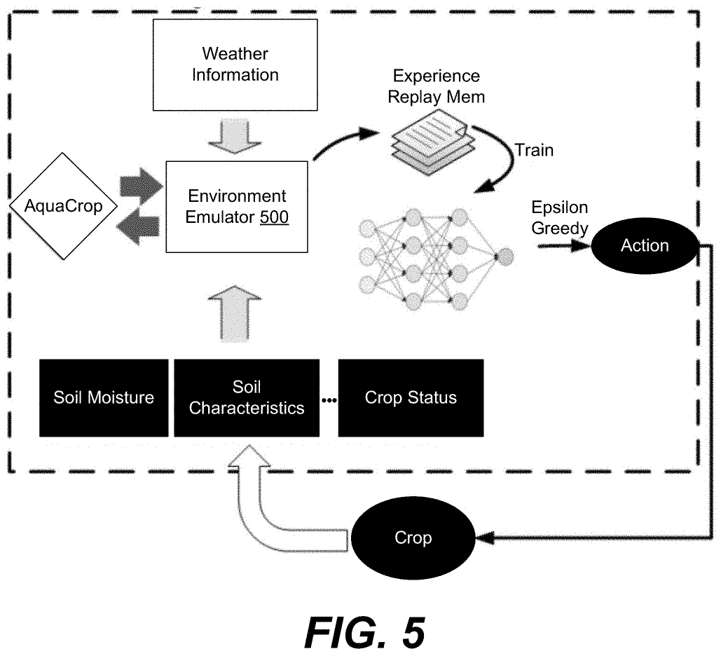

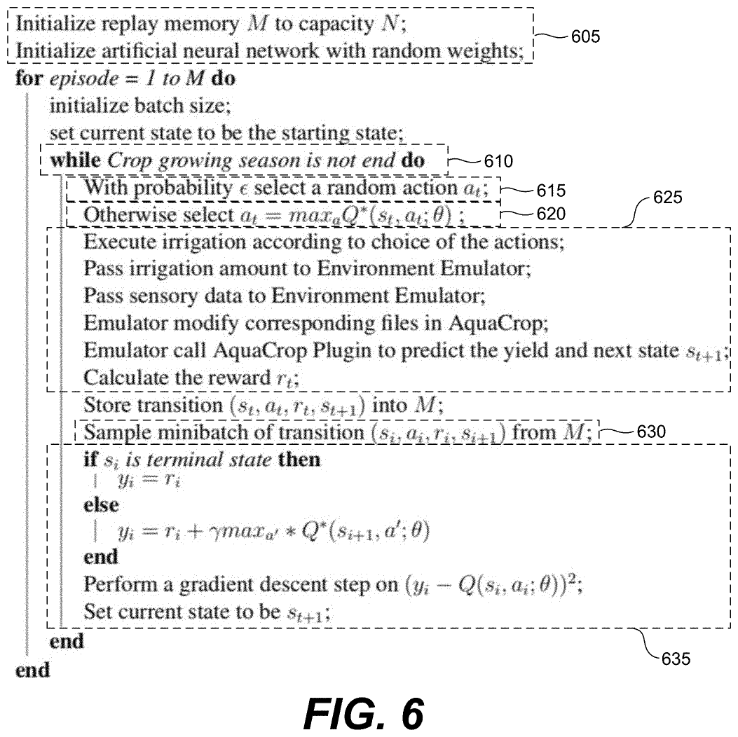

To improve the training performance, combined experience replay (CER) can also be employed, which enforces the last experience contained in the samples. Specifically, at each time step, the agent can select an action according to ε-greedy policy. Based on the current state and action, the environment emulator computes the next state and the subsequent reward. The system structure is depicted in FIG. 5 and a detailed example algorithm process is shown in FIG. 6.

Specifically, with respect to FIG. 6, pseudocode is depicted that directs at least one computing device to perform a method as described herein. First, code block 605 initializes replay memory and an artificial neural network, such as a Q-network. Each training episode can correspond to an entire crop season. Second, code block 610 (e.g., reciting a while loop) iterates through each episode corresponding to an entire crop season until a termination condition is satisfied. Code block 615 selects a random action to explore given a probability epsilon. Otherwise, in code block 620, the best action so far is identified. In other words, at each time step of one episode, a random irrigation action can be selected with a certain probability, otherwise the irrigation action that can maximize the Q value function is selected. Code block 625 irrigates and calculates a net return using a real environment and/or a crop model, such as AquaCrop, and a next state sₜ₊₁ is determined. Code block 630 stores a transition (sₜ, aₜ, rₜ, sₜ₊₁) in replay memory. Finally, code block 635 experience replay is conducted, where a random minibatch of transitions is sampled from the replay memory, and a gradient descent step is performed (referred to as “experience replay”).

Referring back to FIG. 5, an environment emulator 500 is shown which may include program instructions that direct a computing device to interact with a crop and/or weather modeling service, such as AquaCrop. The environment emulator 500 can pass data to AquaCrop and request one round crop simulation. After simulation, the environment emulator 500 will read the simulation results and use necessary information to calculate the values of reward and next state.

Automated Micro-Irrigation (Fixed Zone System) Zone Scheduling

Although the proposed deep reinforcement learning irrigation optimization approach can determine optimal or near-optimal water application for a certain irrigation management zone, the detailed scheduling for control use with the irrigation machine remains problematic. Generally, a center pivot irrigation system can adapt its speed to achieve differing water application rates; however, in the scheduling of fixed-zone systems, such as that of a subsurface drip irrigation system, a landscape irrigation system, or a greenhouse/nursery system, the time of application can be varied, but can still be challenging considering the given system hydraulic constraints. The proposed automated zone scheduling approach can overcome these limitations and fully automate the irrigation process by determining the timing of irrigation to provide the desired water application rate(s) for fixed-zone irrigation systems. It can also protect the irrigation system from large fluctuations in flow and pressure and assure system operations within the system hydraulic constraints.

Problem Formulation. The irrigation task of an individual zone can be seen as an independent task that can contain several time slots of irrigation to apply a certain amount of water. Operational line pressure for drip tape or emitter lines needs to be balanced during irrigation events to avoid damage from over pressurization of the system. In addition, multiple operations (e.g. activating valves) at the same time must be avoided, since this can cause a large pressure fluctuation (water hammer) that can damage the system. Therefore, multi-zonal irrigation can be treated as a problem of scheduling several competing tasks that require exclusive use of a common resource. In some embodiments, the deep reinforcement learning module 105 can determine a daily water application for each zone (or for another predetermined time), so it can be desirable to finish all irrigation within a given time period (such as a day). However, it may be impossible to schedule and complete all irrigation tasks within the given period (one day, for instance). In this case, scheduling bias is avoided, which means certain zones should not preempt resources of the irrigation system. Thus, the scheduling effort of the automated zone scheduling module 110 is to minimize the total irrigation time and balance the water needs of the irrigation zones subject to hydraulic constraints. In other words, the controller 100 described herein can avoid conflict with one or more hydraulic constraint, or the controller 100 can determine an irrigation schedule to operate an irrigation system within hydraulic constraints.

A set Z={z₁, z₂, . . . , zₙ} denotes n irrigation tasks. These tasks require to use the common resource of irrigation, such as the well or pump capacity, which can serve only m tasks at a given time. Each task zᵢ has a certain goal Tᵢ, the time corresponding to the water application amount of zone i. Additionally, let tᵢⱼ^{start} be the j^{th} start time of irrigation of zone i and tᵢⱼ^{end} be the j^{th} end time of irrigation of zone i. Let tᵢₗₐₛₜ^{end} be the last irrigation end time of zone i. The number of management zones can be very large so the water needs of zones may not be fully met before the next needed irrigation event. In this scenario, time becomes critical and therefore the smaller the maximum end time of zones is preferable. The mathematic formulation of this goal can be stated as follows:

$${S}_{1} = argmin \{ {max}_{i} {t}_{i last}^{end} \} . \qquad ( eq . 6 )$$

In addition, to address the end day soil profile status in the worst scenario is still acceptable, it is a necessity to balance the water needs of different zones. This goal can be described as follows:

$${S}_{2} = arg {min}_{{t}_{ij}^{start} \leq {t}_{ij}^{end}} \{ {max}_{i} ( {T}_{i} - {{\sum }_{j = 1}}^{{k}_{i}} ( {t}_{i j}^{end} - {t}_{ij}^{start} ) ) \} . \qquad ( eq . 7 )$$

To protect the irrigation system from large pressure fluctuations, the program (and solution) must assure that no more than one operation happens at the same time.

Hydraulic constraints can be defined as three mathematical equations, namely, ∀_{p≠q}(tₚ^{end}−t_{q}^{end}≥α) ∀_{p≠q}(tₚ^{start}−t_{q}^{start}≥α), and ∀_{p≠q}(tₚ^{start}−t_{q}^{end}≥α), where a indicates the minimum operational transitional time interval between two operations to avoid abrupt changes of water pressure and water flow.

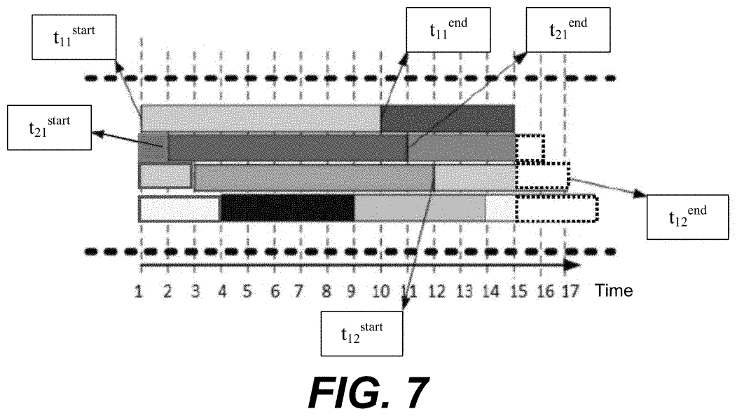

In addition, to avoid waste of water, the zone scheduling solution also needs to satisfy the condition ∀ᵢ(Tᵢ−Σⱼ₌₁^{k}^{ᵢ}(tᵢⱼ^{end}−tᵢⱼ^{start})≥0). The start and end times need to be valid, meaning the start time cannot be lower than 0 and the end time cannot go beyond one day (or other application-specific predetermined interval) (e.g., assuming the deep reinforcement learning module 105 computes a possible solution water application amount in one time period, e.g. a day). Thus, this constraint can be described as ∀_{i,j}(0≤tᵢⱼ^{start}≤tᵢⱼ^{end}≤1440), where the unit is in minutes, and the numeric value is the maximum irrigation period; in the case of one day, that is 1440 minutes. FIG. 7 shows a valid zone scheduling solution determined within given hydraulic constraints of the system.

The time complexity of computing the optimal solution to both equations (6) and (7), under the system constraints, is exponential. However, for a fully automated irrigation system, the irrigation schedule needs to be computed within a short time using general embedded system, such as those that use low-cost circuitry and microcontrollers. Therefore, it is important to use a fast executing routine, instead of an optimal solution (e.g., overall vs. intermediate optimal solution) for the scheduling of multiple zones in one irrigation step. In this effort, a greedy heuristic can be employed to achieve linear time complexity. Typically, a greedy algorithm will go through a sequence of steps with a set of choices at each step. Notably, however, greedy algorithms do not always yield optimal solutions.

The basic strategy of determination includes making the best choice at each step without considering all the subsequent steps. To achieve the goal that minimizes the total irrigation time, the routine can start a new task as long as it is feasible to do so. To achieve the goal that minimizes the maximum remaining time of all the tasks, the zone with the most water needs (longest run time) can be handled first. Also, the routine assures that the respective choice does not violate hydraulic constraints of the system.

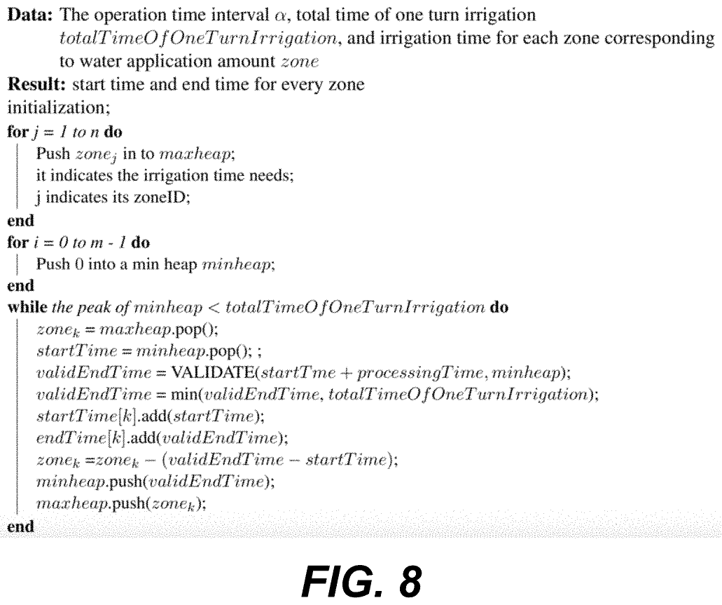

Guided by these general principles, a detailed algorithm is depicted in FIG. 8. The irrigation tasks with corresponding zone identifiers (IDs) are put into a max-heap, which is a data structure that enables retrieval of the maximum value in constant time complexity. Certain irrigation systems only allow m zones to irrigate simultaneously due to the physical limit (e.g., an operational parameter, such as irrigation supply flow capacity). Thus, a min-heap of size m is initialized with values {0, a, 2a, . . . , (m−1)α}, where a is a minimum operation time interval. To avoid one “heavy” task from occupying the resource for an extended time, the maximum irrigation processing time limit is enforced. Once the irrigation time of one zone exceeds the processing (operational) time, that zone is forced to release the resource to the controller. Obviously, the start time is always the minimum value in the min-heap. The decision-making aspect of the end time is subtler than the start time.

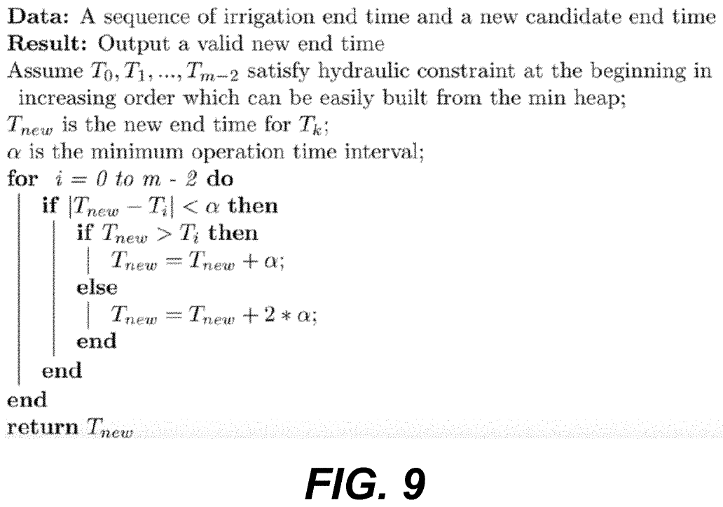

A VALIDATE algorithm is shown and described herein to ensure that the end time does not conflict with other end times and start times. An example of VALIDATE algorithm is shown in FIG. 9. If one ignores the hydraulic constraints of the system, then, the end time is simply the start time plus the processing time. However, it is difficult to solve this problem optimally considering the system hydraulic constraints. The problem can thus be described as: given a value (operational end time), an increasing sequence of numbers, and the difference of each number in the sequence is larger than the minimum interval a, one needs to make the differences of every pair of numbers in this sequence still larger than the minimum interval after inserting this value and by changing the value as little as possible. The proposed VALIDATE algorithm is one way to solve this determination problem. After obtaining the irrigation end time, the zone is then updated with a new water need after this irrigation cycle and it is pushed back to max-heap.

Deep Reinforcement Learning Irrigation Optimization. To evaluate the proposed deep reinforcement learning irrigation optimization approach, a series of simulations was conducted. The proposed approach is compared with three other irrigation solution approaches, namely, reinforcement learning (Q learning) irrigation, threshold-based irrigation, and fixed irrigation. Detailed configurations are provided in Table 1.

TABLE 1
Detailed Configurations

| | |
|---|---|
| Replay memory size of DQN | 10000 |
| Learning rate for DQN | 0.001 |
| Learning rate for Q learning | 0.25 |
| Number of episodes | 400 |
| Action size | 20 |
| Time step | 1 day |
| Initial epsilon | 1 |
| Epsilon decay | 0.985 |
| Number of hidden layers | 2 |
| Number of hidden units of each layer | 20 |
| Discount factor | 0.999 |

In the simulations, irrigation water amount (mm) of actions are {0, 0.5, 1, . . . , 9.5}. A fixed irrigation demand requirement can include irrigating 50 mm every ten days, or other similar requirement. The same state definitions are used in existing system with Q learning, which is shown in Table 2. The state of DQN is the observation of actual field conditions. It can be a tuple of sensing data from multiple resources. In the evaluations performed by the inventors, the state is defined by the date, the crop stage, precipitation, irrigation, reference evapotranspiration (ET), total water content in effective root zone, and water content in effective root zone at the upper threshold for stomatal closure. The header rows are ranges of water content level (mm). The header columns are time steps (days). Each entry in the table is a state identifier. The states can additionally be defined by additional input conditions, such as fertility, chemical requirements, and imagery assessments.

TABLE 2
State Definitions of Q Learning Irrigation

| State | <=320 | (320,325] | (325,330] | (330,340] | >340 |
|---|---|---|---|---|---|
| <=39 | 1 | 2 | 3 | 4 | 5 |
| <=60 | 6 | 7 | 8 | 9 | 10 |
| <=81 | 11 | 12 | 13 | 14 | 15 |
| >81 | 16 | 17 | 18 | 19 | 20 |

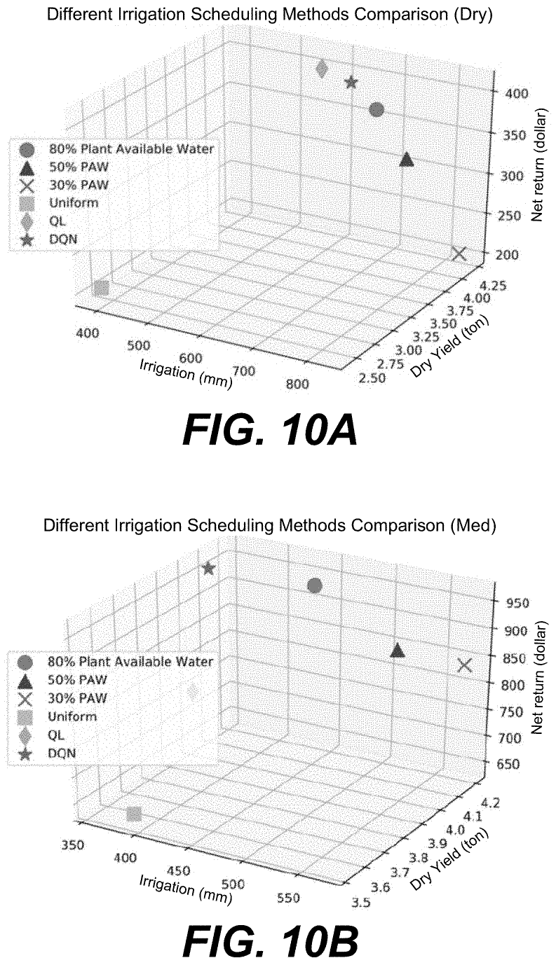

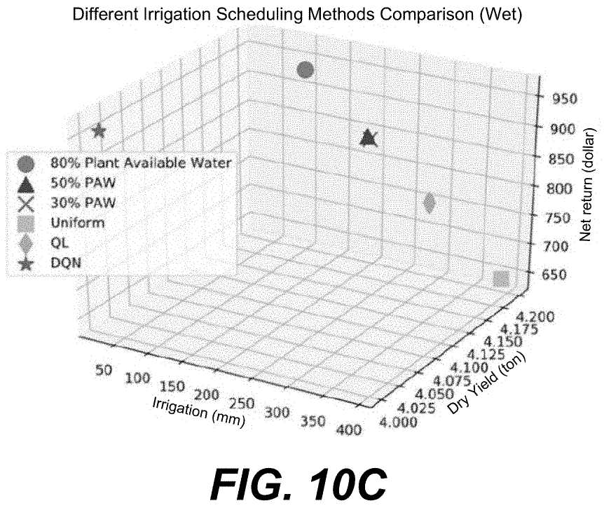

Table 3 shows the results including dry (crop) yield, total irrigation amount, and net return. To better demonstrate the results, all the results are depicted in a three-dimensional figure, which is shown in FIGS. 10A-10C. It is worth noting that, in urban and landscape applications, maximum yield is not necessarily maximum crop yield. For instance, in some landscape applications, maximum yield can be a desired “greenness level,” which is different than a maximum crop yield or economic net return.

FIGS. 10A-10C are results for dry weather conditions, moderate weather conditions, and wet weather conditions, respectively. From Table 3 and FIGS. 10A-10C, the proposed deep reinforcement learning (DQN) irrigation module 105 described herein outperforms the other approaches for moderate and wet weather conditions, and it is very close to the best for dry weather condition.

TABLE 3
Comparison of Different Irrigation Scheduling Methods
under Different Weather Conditions (Wheat)

| Irrigation | Weather | Dry Yield | Irrigation | Net Return |
|---|---|---|---|---|
| Method | Conditions | (ton) | (mm) | ($) |
| DQN | Dry | 4.131 | 624 | 391 |
| | Moderate | 4.068 | 358 | 642 |
| | Wet | 4.001 | 25 | 956 |
| Q Learning | Dry | 4.029 | 582 | 408 |
| | Moderate | 3.979 | 346 | 632 |
| | Wet | 4.199 | 283 | 749 |
| 80% PAW | Dry | 4.181 | 666.5 | 361 |
| allowable | Moderate | 4.182 | 437 | 591 |
| depletion | Wet | 4.199 | 99.1 | 933 |
| 50% PAW | Dry | 4.196 | 724.1 | 307 |
| allowable | Moderate | 4.197 | 511.8 | 520 |
| depletion | Wet | 4.199 | 191 | 841 |
| 30% PAW | Dry | 4.199 | 830.6 | 201 |
| allowable | Moderate | 4.199 | 572.5 | 460 |
| depletion | Wet | 4.199 | 195 | 837 |
| Fixed | Dry | 2.424 | 390 | 205 |
| Irrigation | Moderate | 3.528 | 390 | 477 |
| | Wet | 4.199 | 390 | 642 |

Note: PAW refers to Plant Available Water. 80% PAW indicates an irrigation triggering threshold of 80% depletion of the soil's plant available water storage (Managed Allowable Depletion). Similarly, 50% PAW and 30% PAW represent irrigation trigger thresholds of 50% and 30% depletion of plant available soil water.

Simulations using different crops mimic the same results as that of the simulations of the differing weather conditions. However, instead of changing weather conditions, the crop types were changed while keeping the weather conditions constant. The simulations were conducted on wheat, corn, and soybean crops, although it is readily understood that the embodiments described herein can be employed with other crops.

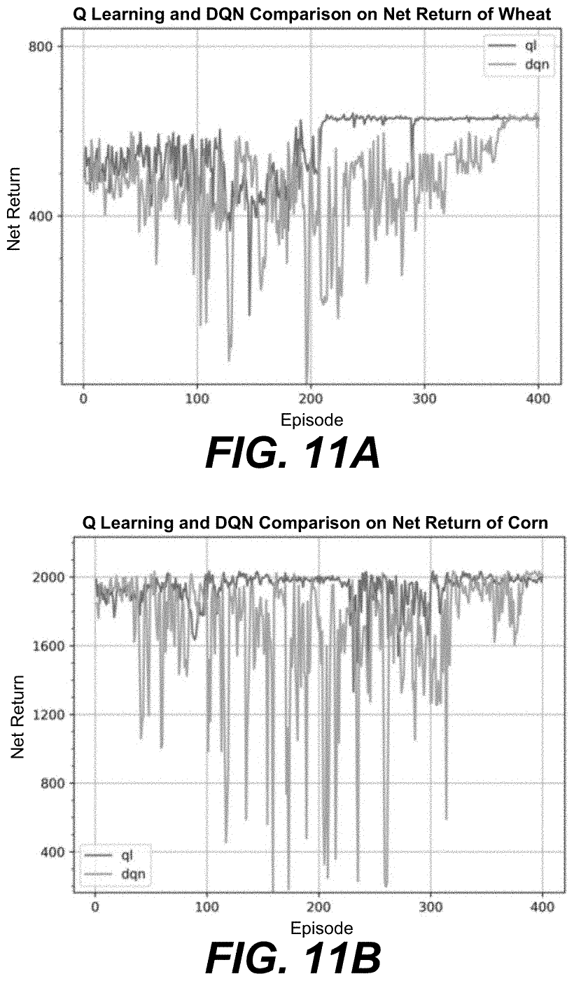

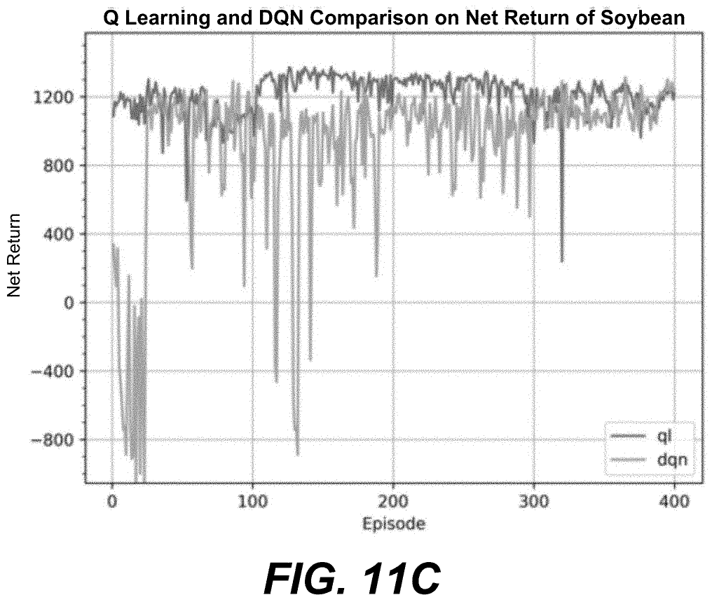

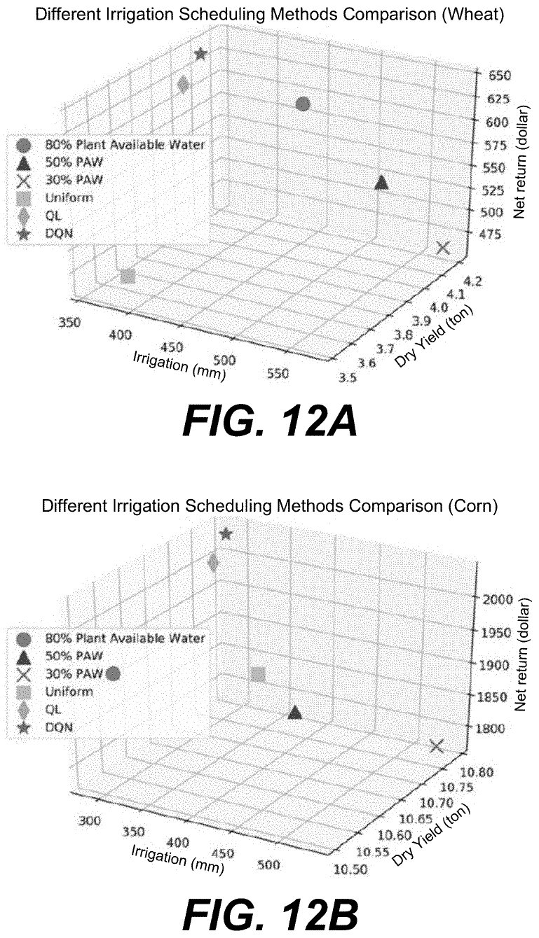

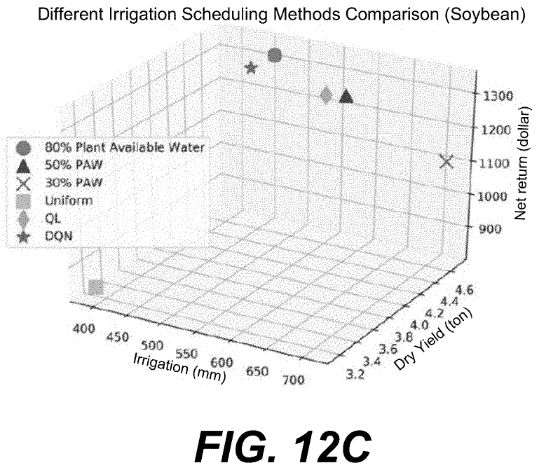

FIG. 11 shows the learning curves for both Q learning and deep Q networks, which indicate the learning process. Both methods converge to some values after a certain number of iterations of training. As shown in Table 4 and FIG. 12, the results indicate that the proposed DQN methods described herein obtain the highest net returns for corn and wheat, and the net return for soybean is very close to the largest value.

TABLE 4
Comparison of Different Irrigation Scheduling
Methods on Different Crop Types

| Irrigation | Crop | Dry Yield | Irrigation | Net Return |
|---|---|---|---|---|
| Method | Types | (ton) | (mm) | ($) |
| DQN | Wheat | 4.068 | 358 | 642 |
| | Corn | 10.79 | 286 | 2033 |
| | Soybean | 4.531 | 449 | 1301 |
| Q Learning | Wheat | 3.979 | 346 | 632 |
| | Corn | 10.741 | 301 | 2007 |
| | Soybean | 4.636 | 546 | 1244 |
| 80% PAW | Wheat | 4.182 | 437 | 591 |
| allowable | Corn | 10.506 | 311.1 | 1947 |
| depletion | Soybean | 4.653 | 469 | 1328 |
| 50% PAW | Wheat | 4.192 | 511.8 | 520 |
| allowable | Corn | 10.656 | 432.8 | 1857 |
| depletion | Soybean | 4.691 | 568.4 | 1243 |
| 30% PAW | Wheat | 4.199 | 572.5 | 460 |
| allowable | Corn | 10.774 | 536.2 | 1780 |
| depletion | Soybean | 4.705 | 712 | 1105 |
| Fixed | Wheat | 3.528 | 390 | 477 |
| Irrigation | Corn | 10.659 | 390 | 1901 |
| | Soybean | 3.167 | 390 | 833 |

Automated Zone Scheduling Module. The proposed zone scheduling method automates complex, multi-zone irrigations, and balances the water needs among the zones. Within the same given irrigation time, the method described herein can improve probability of maintaining the irrigation requirement of all zones in an acceptable watered condition, while other methods may fail to maintain an adequate soil water content for some zones. To further evaluate the outlined zone scheduling process, the proposed method is compared with a naïve automatic scheduling approach. The naïve scheduling method operates the maximum number of zones that can be operated during a period and schedules a constant time irrigation. This constant time is related to the total number of irrigation management zones, and the maximum number of zones that can operate at a time plus the minimum time interval between operations. For instance, if the total number of zones is 32, and the given maximum number of zones that can be operated at a time is 8 with the minimum time interval time of 5 minutes, then the constant irrigation time of the naïve method is 320 minutes.

$$IrrigationTime = \frac{TotalTime * MaxNumOfOperation}{NumOfZones} - MaxNumOfOperations * TimeInterval \qquad ( eq . 8 )$$

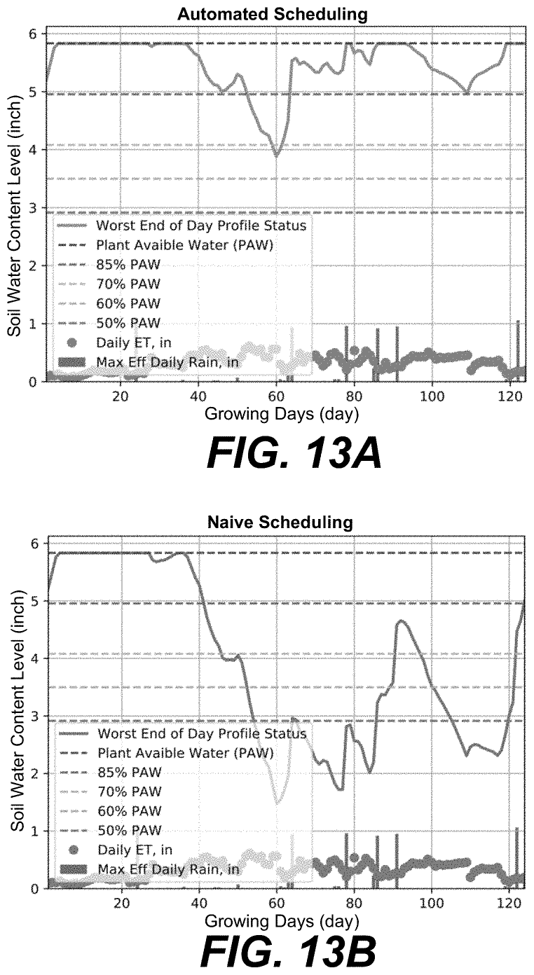

FIG. 13 shows the simulation results of the automated scheduling module 110. It can be seen that the smart scheduling method implemented by the automated zone schedule module 110 outperforms the naïve method. Notably, the automated zone scheduling module 110 can better balance the water needs among the respective zones and maintain a more desired overall profile status agronomically. This simulation configuration and input data are derived from actual operational field data collected at the Texas A&M AgriLife Research field site at Bushland, Tex. The detailed information of configuration is shown in Table 5. In the simulation, different zones may irrigate different crops thus having differing water needs. To simulate this scenario, 32 different crop ET data are required corresponding to the different zones and are generated from the historical (actual) ET data multiplied by a uniform distribution random number between 0.9 to 1.5.

| Field | Number of irrigation management zones | 32 | |
|---|---|---|---|
| | Irrigated field acreage | 10.6 | acres |
| | Area per zone | 0.3312 | acre |
| | Well output | 80 | gpm |
| Irrigation | Max Line Pressure | 30 | psi |
| System | Desired operating tape pressure range | 20 to 26 psi | |
| Constraints | Application output rate per zone | 11.4 | gpm |

| | |
|---|---|
| Max number of zones to operate at a time | 8 |

In this work, a deep reinforcement learning irrigation module 105 is described and evaluated relative to prior scheduling and control systems. Results indicate the deep reinforcement learning irrigation module 105 can accurately represent complicated irrigation context and determine precise water application amounts, thus addressing a high WUE. Through a combination with a third-party model, such as the AquaCrop model, the deep reinforcement learning irrigation module 105 is shown to overcome insufficient data issues while enabling the system to determine acceptable, profitable solutions while continuously learning during the production season. Evaluations conducted of differing crop types and multiple weather conditions indicate that the proposed method outperforms all other methods in most cases.

To fully automate the irrigation process for micro-irrigation or other fixed-zone irrigation systems, a smart automated zone scheduling module 110 is described. The automated zone scheduling module 110 can replace manual computations that are required to determine start/stop times to provide the desired water application rate and timing for fixed-zone irrigation systems. This can be done while protecting the system from large fluctuations in flow and pressure and assures system operation within the given hydraulic constraints (e.g., practical constraints of flows, pressures, system capacity, etc.). Additionally, the automated zone scheduling module 110 can handle many zones and balance the water needs among these multiple zones. Simulation results illustrate that the proposed smart scheduling outperforms the naïve automated zone scheduling method.

The operations of the controller 100 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, the operations of the controller 100 can be implemented by logic, routine, or an application that comprises software or program code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

Further, any logic or application described herein, including the operations performed by the controller 100, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in a same computing environment. Additionally, it is understood that terms such as “application,” “service,” “system,” “engine,” “module,” “routine,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. The term “agent” as used herein can refer to the controller 100, a component of the controller 100 (e.g., such as a software application or collection of software routines), or at least one computing device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Clause 1. A system for deep reinforcement learning-based irrigation control to maintain or increase a crop yield (or other desired crop status) or reduce water use, comprising: at least one computing device; and program instructions stored in memory and executable by the at least one computing device that, when executed, direct the at least one computing device to: determine, by a deep reinforcement learning (RL) module that implements a deep reinforcement learning routine, an amount of water to be applied to at least one crop in at least one of a plurality of irrigation management zones; determine, by an automated zone scheduling module, a start time and an end time to be applied to the at least one of the plurality of irrigation management zones based at least in part on the amount of water determined by the deep reinforcement learning module; and instruct an irrigation system to apply irrigation to the at least one of the plurality of irrigation management zones in accordance with the start time and the end time.

Clause 2. The system of clause 1, wherein the at least one computing device is implemented in an irrigation controller.

Clause 3. The system of clause 1-2, wherein the deep reinforcement learning (RL) module determines the amount of water to be applied to the at least one crop in at least one of a plurality of irrigation management zones based on at least one of a hydraulic constraint; a soil moisture (soil water) measurement; a soil characteristic; a status of the at least one crop; imagery data; irrigation status; and weather data.

Clause 4. The system of clause 1-3, wherein the imagery data comprises data obtained by an unmanned aerial vehicle (UAV).

Clause 5. The system of clause 1-4, further comprising a plurality of soil sensors placed in individual ones of the plurality of irrigation management zones, the soil sensors being configured to generate at least one of: the soil moisture (soil water) measurement; the soil characteristics; and the status of the at least one crop.

Clause 6. The system of clause 1-5, wherein the deep reinforcement learning (RL) module further determines an amount of a chemical to be introduced with the water to be applied to the at least one crop in at least one of the plurality of irrigation management zones.

Clause 7. The system of clause 1-6, wherein the deep reinforcement learning module, causes, for a given state of a total soil moisture, the computing device to: perform an action, the action comprising waiting or irrigating the at least one crop; and assign an immediate reward to a state-action pair, the state-action pair comprising the given state of the total soil moisture and the action performed.

Clause 8. The system of clause 1-7, wherein the start time and the end time to be applied to the at least one of the plurality of irrigation management zones is determined by the automated zone scheduling module based at least in part on at least one hydraulic constraint.

Clause 9. The system of clause 1-8, wherein the at least one hydraulic constraint comprises: water flow of an irrigation system; water pressure of the irrigation system; water status; or system capacity of the irrigation system.

Clause 10. The system of clause 1-9, wherein the at least one crop comprises at least one of: corn, sorghum, soybean, wheat, citrus, legume, other cultivated crop (agronomic, horticultural, etc.), turf, or landscape planting.

Clause 11. The system of clause 1-10, wherein the deep reinforcement learning module implements a Q-value function prior to the amount of water to be applied to the at least one crop being determined, the Q-value function being approximated by an artificial neural network (NN).

Clause 12. A computer-implemented method for deep reinforcement learning-based irrigation control to maintain or increase a crop yield (or other desired crop status) or reduce water use, comprising: determining an amount of water to be applied to at least one crop in at least one of a plurality of irrigation management zones through execution of a deep reinforcement learning routine; determining a start time and an end time to be applied to the at least one of the plurality of irrigation management zones based at least in part on the amount of water determined by the deep reinforcement learning module; and instructing an irrigation system to apply irrigation to the at least one of the plurality of irrigation management zones in accordance with the start time and the end time.

Clause 13. The computer-implemented method of clause 12, wherein determining the amount of water to be applied to the at least one crop in at least one of the plurality of irrigation management zones is performed using at least one of a hydraulic constraint; a soil moisture measurement; a soil characteristic; a status of the at least one crop; imagery data; irrigation status; and/or weather data.

Clause 14. The computer-implemented method of clause 12-13, wherein the imagery data comprises data obtained by an unmanned aerial vehicle (UAV).

Clause 15. The computer-implemented method of clause 12-14, further comprising collecting data from a plurality of soil sensors placed in individual ones of the plurality of irrigation management zones, the soil sensors being configured to generate at least one of the soil moisture measurement; the soil characteristics; and/or the status of the at least one crop.

Clause 16. The computer-implemented method of clauses 12-15, further comprising determining an amount of a chemical to be introduced with the water to be applied to the at least one crop in at least one of the plurality of irrigation management zones.

Clause 17. The computer-implemented method of clauses 12-16, further comprising, for a given state of a total soil moisture: performing an action, the action comprising waiting or irrigating the at least one crop; and assigning an immediate reward to a state-action pair, the state-action pair comprising the given state of the total soil moisture and the action performed.

Clause 18. The computer-implemented method of clauses 12-17, wherein the start time and the end time to be applied to the at least one of the plurality of irrigation management zones is determined based at least in part on at least one hydraulic constraint.

Clause 19. The computer-implemented method of clauses 12-18, wherein: the at least one hydraulic constraint comprises: water flow of an irrigation system; water pressure of the irrigation system; water status; or system capacity of the irrigation system; and the at least one crop comprises at least one of: corn, sorghum, soybean, wheat, citrus, legume, or other cultivated crop (agronomic, horticultural, etc.), turf or landscape planting.

Clause 20. The computer-implemented method of clauses 12-19, wherein the deep reinforcement learning module implements a Q-value function prior to determining the amount of water to be applied to the at least one crop, the Q-value function being approximated by an artificial neural network (NN).

1. A system for deep reinforcement learning-based irrigation control to maintain or adjust a crop status, or reduce water use, comprising:
at least one computing device; and
program instructions stored in memory and executable by the at least one computing device that, when executed, direct the at least one computing device to:
determine, by a deep reinforcement learning (RL) module that implements a deep reinforcement learning routine, an amount of water to be applied to at least one crop in at least one of a plurality of irrigation management zones;
determine, by an automated zone scheduling module, a start time and an end time to be applied to the at least one of the plurality of irrigation management zones based at least in part on the amount of water determined by the deep reinforcement learning module; and
instruct an irrigation system to apply irrigation to the at least one of the plurality of irrigation management zones in accordance with the start time and the end time.

2. The system of claim 1, wherein the at least one computing device is implemented in an irrigation controller.

3. The system of claim 1, wherein the deep reinforcement learning (RL) module determines the amount of water to be applied to the at least one crop in at least one of a plurality of irrigation management zones based on at least one of: a hydraulic constraint; a soil moisture (soil water) measurement; a soil characteristic; a status of the at least one crop; imagery data; irrigation status; and weather data.

4. The system of claim 3, wherein the imagery data comprises data obtained by an unmanned aerial vehicle (UAV).

5. The system of claim 4, further comprising a plurality of soil sensors placed in individual ones of the plurality of irrigation management zones, the soil sensors being configured to generate at least one of: the soil moisture (soil water) measurement; the soil characteristics; and the status of the at least one crop.

6. The system of claim 1, wherein the deep reinforcement learning (RL) module further determines an amount of a chemical to be introduced with the water to be applied to the at least one crop in at least one of the plurality of irrigation management zones.

7. The system of claim 1, wherein the deep reinforcement learning module, causes, for a given state of a total soil moisture, the computing device to:
perform an action, the action comprising waiting or irrigating the at least one crop; and
obtain an immediate reward for a state-action pair, the state-action pair comprising the given state of the total soil moisture and the action performed.

8. The system of claim 1, wherein the start time and the end time to be applied to the at least one of the plurality of irrigation management zones is determined by the automated zone scheduling module based at least in part on at least one hydraulic constraint.

9. The system of claim 8, wherein the at least one hydraulic constraint comprises: water flow of an irrigation system; water pressure of the irrigation system; water status; or system capacity of the irrigation system.

10. The system of claim 1, wherein the at least one crop comprises at least one of corn, sorghum, soybean, wheat, citrus, legume, cultivated crop, turf, and landscape planting.

11. The system of claim 1, wherein the deep reinforcement learning module implements a Q-value function prior to the amount of water to be applied to the at least one crop being determined, the Q-value function being approximated by an artificial neural network (NN).

12. A computer-implemented method for deep reinforcement learning-based irrigation control to maintain or adjust a desired crop status, or reduce water use, comprising:
determining an amount of water to be applied to at least one crop in at least one of a plurality of irrigation management zones through execution of a deep reinforcement learning routine;
determining a start time and an end time to be applied to the at least one of the plurality of irrigation management zones based at least in part on the amount of water determined by the deep reinforcement learning routine; and
instructing an irrigation system to apply irrigation to the at least one of the plurality of irrigation management zones in accordance with the start time and the end time.

13. The computer-implemented method of claim 12, wherein determining the amount of water to be applied to the at least one crop in at least one of the plurality of irrigation management zones is performed using at least one of: a hydraulic constraint; a soil moisture (soil water) measurement; a soil characteristic; a status of the at least one crop; imagery data; irrigation status; and weather data.

14. The computer-implemented method of claim 13, wherein the imagery data comprises data obtained by an unmanned aerial vehicle (UAV).

15. The computer-implemented method of claim 14, further comprising collecting data from a plurality of soil sensors placed in individual ones of the plurality of irrigation management zones, the soil sensors being configured to generate at least one of the soil moisture (soil water) measurement; the soil characteristics; and the status of the at least one crop.

16. The computer-implemented method of claim 12, further comprising determining an amount of a chemical to be introduced with the water to be applied to the at least one crop in at least one of the plurality of irrigation management zones.

17. The computer-implemented method of claim 12, further comprising, for a given state of a total soil moisture:
performing an action, the action comprising waiting or irrigating the at least one crop; and
assigning an immediate reward to a state-action pair, the state-action pair comprising the given state of the total soil moisture and the action performed.

18. The computer-implemented method of claim 12, wherein the start time and the end time to be applied to the at least one of the plurality of irrigation management zones is determined based at least in part on at least one hydraulic constraint.

19. The computer-implemented method of claim 18, wherein:
the at least one hydraulic constraint comprises: water flow of an irrigation system; water pressure of the irrigation system; water status; or system capacity of the irrigation system; and
the at least one crop comprises at least one of: corn, sorghum, soybean, wheat, citrus, legume, cultivated crop, turf, and landscape planting.

20. The computer-implemented method of claim 12, wherein the deep reinforcement learning module implements a Q-value function prior to determining the amount of water to be applied to the at least one crop, the Q-value function being approximated by an artificial neural network (NN).
